(19) United States
(12) Patent Application Publication
(10) Pub. No.: US 2014/0139946 A1
(43) Pub. Date: May 22, 2014

(54) MAGNETIC RECORDING MEDIUM AND MAGNETIC RECORDING AND REPRODUCING DEVICE

(71) Applicant: SHOWA DENKO K.K., Tokyo (JP)

(72) Inventor: Ichiro OTA, Chiba-shi (JP)

(73) Assignee: SHOWA DENKO K.K., Tokyo (JP)

(21) Appl. No.: 14/079,224

(22) Filed: Nov. 13, 2013

(30) Foreign Application Priority Data
Nov. 19, 2012 (JP) 2012-253179
Oct. 3, 2013 (JP) 2013-208431

(51) Int. Cl. G11B 5/725

(52) U.S. Cl. CPC G11B 5/725
USPC 360/75; 428/833.3; 428/833.1

(57) ABSTRACT

Disclosed is a magnetic recording medium having at minimum a magnetic layer, a protective layer and a lubricant agent layer on a non-magnetic substrate in sequential order, in which the protective layer is formed of carbon or silicon carbide, the lubricant agent layer is formed by being in contact with the protective layer, contains compound A shown in the below general formula (1) and compound B, in which the mass ratio (A/B) of the compound A with respect to the compound B is in the range of 0.05 to 0.9 and the average film thickness of the lubricant agent layer is 0.8 nm to 2 nm.

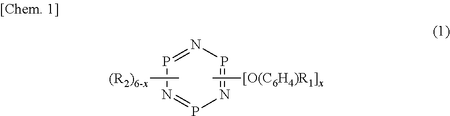

### BACKGROUND OF THE INVENTION

1. Field of the Invention

The present invention relates to a magnetic recording medium suitably used for a magnetic recording and reproducing device such as a hard disk drive and a magnetic recording and reproducing device provided with the same.

Priority is claimed on Japanese Patent Application No. 2012-253179, filed on Nov. 19, 2012 and Japanese Patent Application No. 2013-208431, filed on Oct. 3, 2013, the contents of which are incorporated herein by reference.

2. Description of Related Art

Currently, the track density of magnetic recording mediums has reached 400 kTPI. It is thought that the recording density of a magnetic recording and reproducing device will continuously improve in the future.

In order to enhance the recording density of a magnetic recording and reproducing device, a magnetic recording medium suitable for high recording density is being developed.

In the related art, there is a magnetic recording medium in which a recording layer or the like is laminated on a substrate for the magnetic recording medium, a protective layer such as carbon is formed on the recording layer and a lubricant agent layer is further formed on the protective layer. The protective layer protects information recorded on the recording layer and increases the slidability of a magnetic head. However, sufficient durability of the magnetic recording medium is not obtained by merely providing the protective layer on the recording layer.

Accordingly, a lubricant agent is coated on the surface of a protective layer to form a lubricant agent layer, in general. By providing a lubricant agent layer on a protective layer, it is possible to prevent direct contact of a magnetic head and a protective layer of a magnetic recording and reproducing device and it is possible to significantly reduce the frictional force of a magnetic head sliding on a magnetic recording medium and therefore, durability is enhanced.

As the lubricant agent used in a magnetic recording medium, a perfluoropolyether-based lubricant agent, an aliphatic hydrocarbon-based lubricant agent or the like has been proposed.

For example, Japanese Unexamined Patent Application, First Publication No. S62-66417 discloses a magnetic recording medium coated with a perfluoroalkyl polyether lubricant agent having a structure of HOCH₂—CF₂O—(C₂F₄O)ₚ—(CF₂O)_{q}—CH₂OH (p and q are integers).

In addition, Japanese Unexamined Patent Application, First Publication No. H9-282642 discloses a magnetic recording medium coated with a perfluoroalkyl polyether (tetraol) lubricant agent having a structure of HOCH₂CH(OH)—CH₂OCH₂CF₂O—(C₂F₄O)ₚ—(CF₂O)_{q}—CF₂CH₂OCH₂—CH(OH)CH₂OH (p and q are integers).

Furthermore, Japanese Unexamined Patent Application, First Publication No. 2002-275484 discloses a lubricant agent for a magnetic recording medium having a perfluorooxyalkylene unit selected from —CF₂O— or —CF₂CF₂O— and a phosphazene compound.

Furthermore, in order to enhance a recording density of a magnetic recording and reproducing device, it is necessary that the flying height of a magnetic head be smaller and the magnetic head be closer to the surface of a magnetic recording medium.

However, in many cases, ionic contaminants are present on the surface of a magnetic recording medium in the related art. It is known that many of the ionic contaminants are adhered thereto externally in a manufacturing process of a magnetic recording medium.

In a case where contaminants are present on a magnetic recording medium, the contaminants come into contact with a magnetic head to adhere (transfer) when the magnetic head is close to the surface of the magnetic recording medium. When the contaminants are adhered (transferred) to the magnetic recording medium, recording and reproducing characteristics of the magnetic head is deteriorated and flying stability of the magnetic head is impaired. Accordingly, when manufacturing a magnetic recording medium, it is necessary that contaminants adhered on the magnetic recording medium during the manufacturing process be removed.

For example, Japanese Unexamined Patent Application, First Publication No. 2000-235708 discloses a method in which in order to remove contaminants adhered on a magnetic recording medium, the surface of the magnetic recording medium on which a protective film is formed is scrub-cleaned with pure water, and thus formate ions, oxalate ions, ammonium ions and corrosive ions (SO₄²⁻, NO³⁻, Na⁺) adhered to the surface of the magnetic recording medium are removed and then a lubricant agent is coated on the surface of the magnetic recording medium.

Furthermore, there are cases where contaminants adhered on the magnetic recording medium contain trace amount of ionic organic compounds incorporated into a lubricant agent layer from the ambient environment in a forming process of the lubricant agent layer.

As a method removing ionic contaminants which are contaminants from a lubricant agent layer, for example, a technique using an adjustment method of a fluorine-based solvent disclosed in Japanese Unexamined Patent Application, First Publication No. 2002-45606 is exemplified. Japanese Unexamined Patent Application, First Publication No. 2002-45606 discloses a method of removing contaminants such as fluorine, bromine, chlorine, phosphoric acid, sulfuric acid, nitric acid, nitrous acid, acetic acid, formic acid, (meth)acrylic acid, oxalic acid and phthalic acid mixed in the adjustment process or the like of a lubricant agent using adsorbents such as silica gel, or alumina.

In addition, Japanese Unexamined Patent Application, First Publication No. 2004-51716 discloses an adjustment method of a lubricant agent for a magnetic recording medium. Furthermore, Japanese Unexamined Patent Application, First Publication No. 2004-51716 discloses a method of removing ionic impurities (metal ions such as sodium ions, potassium ions, and inorganic ions such as chloride ions, HCO₃ ions, HSO₄ ions, sulfate ions, ammonium ions, oxalate ions and formate ions) from the lubricant agent containing a compound having a perfluoropolyether structure by a supercritical fluid extraction.

Additionally, Japanese Unexamined Patent Application, First Publication No. 2001-67656 discloses a method of removing ionic impurities and a method of removing ionic impurities in a nonaqueous layer in a lubricant agent.

In addition, Japanese Unexamined Patent Application, First Publication No. 2010-108583 discloses that a lubricant agent layer having a high bonding force with respect to a protective layer and a high coverage is obtained even in a case where the thickness of the protective layer is lowered by using the lubricant agent layer in which a phosphazene compound and a compound having a perfluorooxyalkylene unit are mixed in a specific range.

### SUMMARY OF THE INVENTION

In order to enhance a recording density of the magnetic recording and reproducing device and further reduce a flying height of the magnetic head of the magnetic recording and reproducing device, it is necessary that the thickness of a lubricant agent layer is decreased.

However, there were cases where when the thickness of a lubricant agent layer is thin, voids are formed in the lubricant agent layer to reduce the coverage of the surface of the magnetic recording medium by the lubricant agent layer and a part of a lower layer of the lubricant agent layer is exposed. When the voids are formed in the lubricant agent layer, environmental materials that generate contaminants penetrate into a lower layer of the lubricant agent layer from the voids of the lubricant agent layer and the magnetic recording medium is contaminated.

In more detail, when environmental materials that generate contaminants such as ionic impurities penetrate into a lower layer of the lubricant agent layer from the voids of the lubricant agent layer, the environmental materials penetrated into the lower layer of the lubricant agent layer aggregate ionic components present in the lower layer of the lubricant agent layer, thereby generating contaminants contaminating the magnetic recording medium.

In addition, generally, the inner part of a hard disk drive provided with a magnetic recording medium becomes a high temperature state by recording and reproducing information on the magnetic recording medium by driving the magnetic recording medium. The above-described penetration of environmental materials from the voids of the lubricant agent layer, the aggregation of ionic components present in a lower layer of the lubricant agent layer and the generation of contaminants contaminating the magnetic recording medium become more significant under high temperature conditions.

The present invention has been made in view of the above circumstances and has an object to provide a magnetic recording medium which has a lubricant agent layer capable of coating the surface of a protective layer with high coverage even if the thickness is thin, prevents the aggregation of ionic components present in a lower layer of a lubricant agent layer due to environmental materials penetrated into the lower layer of the lubricant agent layer, can effectively prevent the contamination of the surface of the magnetic recording medium by suppressing the generation of contaminants contaminating the magnetic recording medium and can prevent adhesion (transfer) to a magnetic head of the contaminants present on the magnetic recording medium, and a magnetic recording and reproducing device provided with the same.

### Means for Solving the Problem

The inventors of the invention have conducted an intensive study to solve the above-described problems, and as a result, found that one of ionic contaminants on a magnetic recording medium causing damage and contamination of a magnetic head of a magnetic recording and reproducing device is a material that had not been previously recognized. That is, they found that contaminants generate outgas from a siloxane-based organic Si used as a rubber seal for sealing a magnetic recording and reproducing device as environmental materials that generate contaminants.

In addition, the inventors have repeated studies by focusing on the relationship between the amount of contaminants present on a magnetic recording medium and molecular structures of compounds used in a lubricant agent layer. From the results, the following facts have been found. That is, in a case where compounds having a large molecular structure such as a phosphazene compound as a material of a lubricant agent layer are used, when the film thickness is thin, the lubricant agent layer becomes an island shape or a mesh-like shape. Accordingly, voids into which environmental materials that generate contaminants such as ions penetrate are formed, and as a result, the function as a lubricant agent layer is reduced.

Therefore, the present inventors have intensively studied to obtain a lubricant agent layer which can coat the surface of a protective layer with high coverage that does not become an island shape or a mesh-like shape even if the thickness is reduced. The results showed the following facts. That is, a material in which a specific phosphazene compound and a specific compound are contained in a predetermined ratio as a lubricant agent layer is formed on the protective layer formed of carbon or silicon carbide. Thus, a lubricant agent layer having a high bonding force with respect to a protective layer and capable of coating the surface of the protective layer with high coverage that does not become an island shape or a mesh-like shape is obtained even if the thickness is reduced.

Then, the inventors found that a magnetic recording medium which can effectively prevent the contamination of the surface of a magnetic recording medium and can prevent adhesion (transfer) to a magnetic head of the contaminants present on the magnetic recording medium by using a magnetic recording medium provided with such a lubricant agent layer can be realized, and have made the invention.

That is, the present invention relates to the following.

[1] A magnetic recording medium according to an embodiment of the present invention is a magnetic recording medium having at minimum a magnetic layer, a protective layer and a lubricant agent layer on a non-magnetic substrate in this order, in which the protective layer is formed of carbon or silicon carbide, the lubricant agent layer is formed by being in contact with the protective layer, contains compound A shown in the below general formula (1) and compound B which is any one selected from compound B1 shown in the below general formula (2), compound B2 shown in the below general formula (3), compound B3 shown in the below general formula (4) and compound B4 shown in the below general formula (5), in which the mass ratio (A/B) of the compound A with respect to the compound B is in the range of 0.05 to 0.9 and the average film thickness of the lubricant agent layer is 0.8 nm to 2 nm.

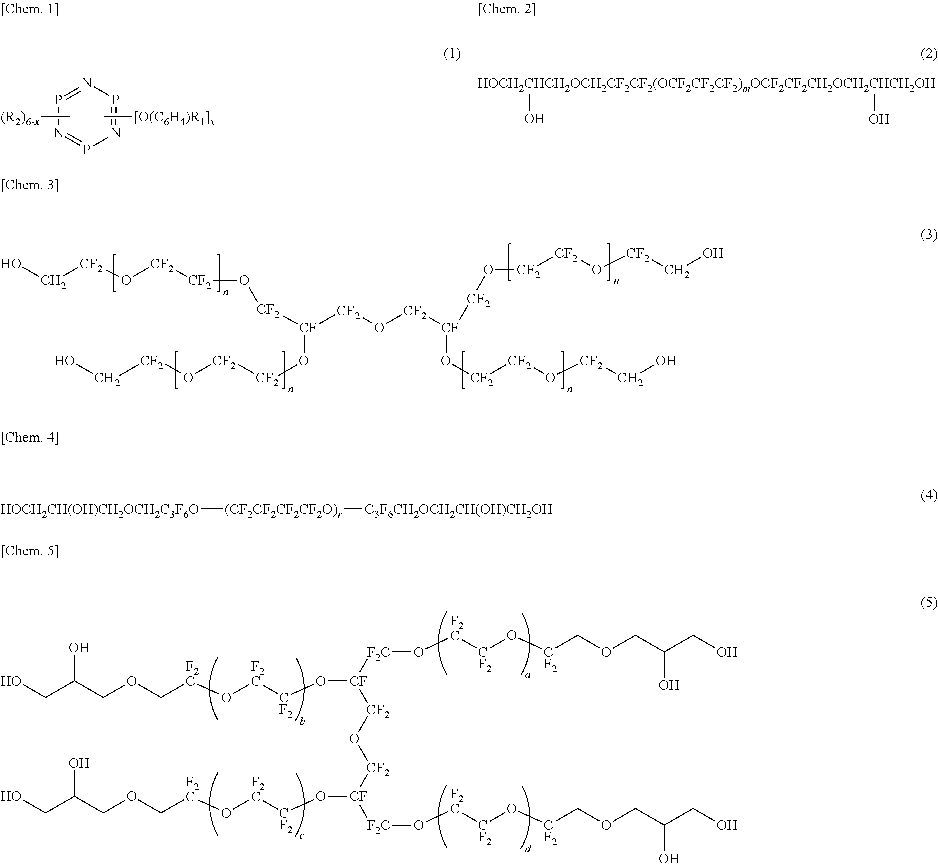

[In the general formula (1), x is an integer of 1 to 5, R₁ is any one of a hydrogen atom, an alkyl group having 1 to 4 carbon atoms or a halogenated alkyl group having 1 to 4 carbon atoms and R₂ is a substituent of which a terminal group is —CH₂OH or —CH(OH)CH₂OH. In the above general formula (2), m is an integer in the range of 4 to 60. In the above general formula (3), n is an integer in the range of 4 to 36. In the above general formula (4), r is an integer in the range of 4 to 60. In the above general formula (5), a, b, c and d are integers in the range of 4 to 40.]

[2] In the magnetic recording medium described in [1], x is 5, R₁ is CF₃ and R₂ may be —OCH₂CF₂O(CF₂CF₂O)ₜ(CF₂O)ᵤCF₂CH₂OH (t is 10.5 and u is 10.1) in the above general formula (1).

[3] In the magnetic recording medium described in [1], x is 5, R₁ is CF₃ and R₂ may be —OCH₂CF₂O(CF₂CF₂O)ₚ(CF₂O)_{q}CF₂CH₂OCH₂CH(OH)CH₂OH (p is 10.7 and q is 10.4) in the above general formula (1).

[4] In the magnetic recording medium described in [1], x is 4, R₁ is CF₃ and R₂ may be a substituent having a terminal group of —CH(OH)CH₂OH in the above general formula (1).

[5] In the magnetic recording medium described in any one of [1] to [4], the compound B is compound B1 shown in the above general formula (2) or compound B3 shown in the above general formula (4) and the average molecular weight of the compound B may be in the range of 1000 to 8000.

[6] In the magnetic recording medium described in any one of [1] to [4], the compound B is compound B2 shown in the above general formula (3) or compound B4 shown in the above general formula (5) and the average molecular weight of the compound B may be in the range of 1000 to 5000.

[7] A magnetic recording and reproducing device according to an embodiment of the present invention is a magnetic recording and reproducing device provided with a magnetic recording medium described in any one of [1] to [6], a medium driving portion to drive the magnetic recording medium to a recording direction, a magnetic head that records and reproduces information on the magnetic recording medium, a head moving portion that relatively moves the magnetic head with respect to the magnetic recording medium and a recording and reproducing signal processing portion to process recording and reproducing signals from the magnetic head.

### Effects of the Invention

The magnetic recording medium of the present invention is provided with a lubricant agent layer which is bonded to a protective layer by a high bonding force and can coat the surface of the protective layer with high coverage so as not to become an island shape or a mesh-like shape even if the thickness is reduced. Thus, in the magnetic recording medium of the present invention, the penetration of environmental materials that generate contaminants such as ionic impurities from the voids of the lubricant agent layer is prevented. Accordingly, in the magnetic recording medium of the present invention, contamination of the magnetic recording medium in which environmental materials that generate contaminants such as ionic impurities penetrate from voids of the lubricant agent layer, the environmental materials penetrated into a lower layer of the lubricant agent layer aggregate ionic components present in the lower layer of the lubricant agent layer and the contaminants contaminating the magnetic recording medium are generated is effectively prevented. Accordingly, the magnetic recording medium of the present invention has a small amount of contaminants present on the magnetic recording medium.

Furthermore, the magnetic recording and reproducing device of the present invention is provided with the magnetic recording medium of the present invention on which a small amount of contaminants is present. Accordingly, the magnetic recording and reproducing device of the present invention is a device in which the deterioration in recording and reproducing characteristics or the impairing of flying stability due to the transfer of the contaminants present on the magnetic recording medium to the magnetic head of the magnetic recording and reproducing device is prevented. As a result, the magnetic recording and reproducing device of the present invention has a stable magnetic recording and reproducing characteristics.

Furthermore, the magnetic recording and reproducing device of the present invention has a lubricant agent layer which can effectively prevent contamination of the surface on a magnetic recording medium even if the thickness is thin. Accordingly, the magnetic recording medium of the present invention can cope with the further improvement in a recording density by making the thickness of the lubricant agent layer sufficiently thin. Furthermore, the magnetic recording medium of the present invention has magnetic recording and reproducing characteristics which are hard to be contaminated, excellent in environmental resistance and stable even in high temperature by making the thickness of the lubricant agent layer sufficiently thin.

### BRIEF DESCRIPTION OF THE DRAWINGS

FIG. 1 is a cross-sectional schematic view showing an example of a magnetic recording medium of the present invention.

FIG. 2 is a perspective view showing an example of the magnetic recording medium of the present invention.

### PREFERRED EMBODIMENTS

Hereinafter, the embodiments of the invention will be described in detail.

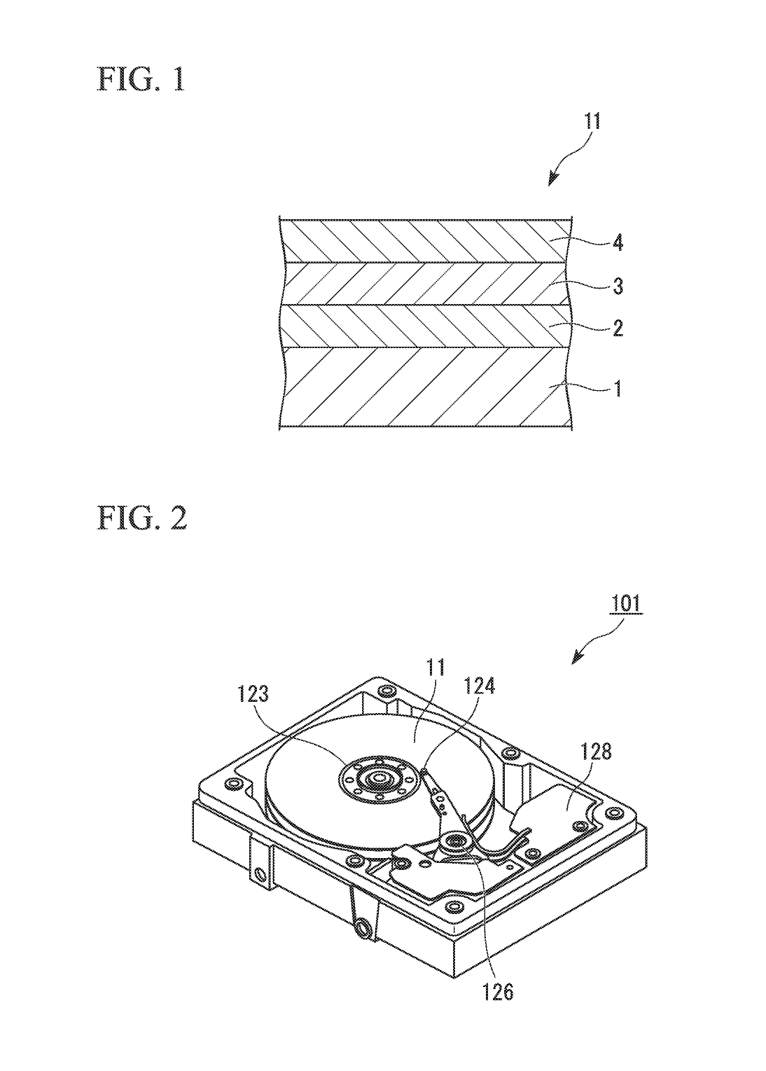

FIG. 1 is a cross-sectional schematic view showing an example of the magnetic recording medium according to an embodiment of the present invention.

As shown in FIG. 1, a magnetic recording medium 11 according to an embodiment of the present invention is a magnetic recording medium in which the magnetic layer 2, a protective layer 3 and a lubricant agent layer 4 are laminated on a non-magnetic substrate 1 in this order.

Moreover, in an embodiment of the present invention, a description will be provided using a case where layers are laminated between a non-magnetic substrate 1 and the magnetic layer 2 in the order an adhesion layer, a soft magnetic underlayer, a seed layer and an orientation control layer, as an example. If necessary, an adhesion layer, a soft magnetic underlayer and an orientation control layer are provided and a part or the entirety among these may not be provided.

<Non-Magnetic Substrate>

As the non-magnetic substrate 1, a substrate having a film formed of NiP or NiP alloy on a substrate formed of metals or alloy materials such as aluminum or aluminum alloy can be used. Furthermore, as the non-magnetic substrate 1, a substrate formed of non-metallic materials such as glass, ceramics, silicon, silicon carbide, carbon and a resin may be used and a substrate having a film formed of NiP or NiP alloy on a substrate formed of the non-metallic material may be used.

(Adhesion Layer)

An adhesion layer prevents a progress of corrosion of the non-magnetic substrate 1 in a case where the non-magnetic substrate 1 is arranged by being in contact with a soft magnetic underlayer provided on the adhesion layer. As a material of the adhesion layer, for example, Cr, Cr alloy, Ti, Ti alloy can be suitably selected. The thickness of an adhesion layer is preferably 2 nm or greater such that sufficient efficiency is obtained by providing an adhesion layer.

For example, the adhesion layer can be formed using a sputtering method.

(Soft Magnetic Underlayer)

A soft magnetic underlayer preferably has a structure in which a first soft magnetic film, an intermediate layer formed of a Ru film and a second soft magnetic film are laminated in order. That is, a soft magnetic underlayer preferably has a structure in which soft magnetic films of the top and bottom of an intermediate layer are anti-Ferro coupling (AFC)-bonded by interposing an intermediate layer formed of a Ru film between two laminated soft magnetic layers. By having a structure in which a soft magnetic underlayer is AFC-bonded, resistance with respect to the magnetic field from the outside and resistance with respect to WATE (Wide Area Tack Erasure) phenomenon which is a specific problem in the perpendicular magnetic recording can be enhanced.

The film thickness of a soft magnetic underlayer is preferably in the range of 15 nm to 80 nm and more preferably in the range of 20 nm to 50 nm. When the film thickness of a soft magnetic underlayer is less than 15 nm, a magnetic flux cannot be sufficiently absorbed from a magnetic head, writing becomes insufficient, there is a possibility that the recording and reproducing characteristics is deteriorated and therefore, it is not preferable. On the other hand, when the film thickness of a soft magnetic underlayer is greater than 80 nm, productivity is significantly reduced and therefore, it is not preferable.

The first and the second soft magnetic films are preferably formed of CoFe alloy. In a case where the first and the second soft magnetic films are formed of CoFe alloy, high saturation magnetic flux density Bs (1.4 (T) or greater) can be achieved.

Furthermore, any one of Zr, Ta and Nb is preferably added to CoFe alloy used in the first and the second soft magnetic film. Thus, amorphization of the first and the second soft magnetic films is promoted, the orientation of a seed layer can be enhanced and the flying height of a magnetic head can be reduced.

The soft magnetic underlayer can be formed using a sputtering method.

(Seed Layer)

A seed layer is used to control the orientation and the crystal size of an orientation control layer and the magnetic layer 2 provided thereon. That is, a seed layer is provided in order to increase a component of a magnetic flux, which is generated from a magnetic head and perpendicular to a substrate surface, and fix the direction of a magnetization of the magnetic layer 2 in a perpendicular direction to the non-magnetic substrate 1 more firmly.

A seed layer is preferable formed of NiW alloy. In a case where a seed layer is formed of NiW alloy, if necessary, elements other than B, Mn, Ru, Pt, Mo, Ta and the like may be added to NiW alloy.

The film thickness of a seed layer is preferably in the range of 2 nm to 20 nm. When the film thickness of a seed layer is less than 2 nm, there are cases when an effect of providing a seed layer is not sufficiently obtained. On the other hand, when the film thickness of a seed layer is greater than 20 nm, the crystal size is increased and therefore, it is not preferable.

The seed layer can be formed using a sputtering method.

(Orientation Control Layer)

An orientation control layer is used to control the orientation of the magnetic layer 2 so that it is excellent. The orientation control layer is preferably formed of a Ru or Ru alloy.

The film thickness of an orientation control layer is preferably in the range of 5 nm to 30 nm. By making the film thickness of an orientation control layer be 30 nm or less, the distance between a magnetic head and a soft magnetic underlayer becomes small and the magnetic flux from the magnetic head can be made steep. Furthermore, by making the film thickness of an orientation control layer 5 nm or greater, the orientation of the magnetic layer 2 can be controlled excellently.

An orientation control layer may be formed of one layer and may be formed of a plurality of layers. In a case where an orientation control layer is formed of a plurality of layers, the entirety of the orientation control layer may be formed of the same material, and at least one part of the orientation control layer may be formed of a material different from the other part of the orientation control layer.

The orientation control layer can be formed using a sputtering method.

<Magnetic Layer>

The magnetic layer 2 is formed of a magnetic film in which an easy axis of magnetization is oriented vertically with respect to a substrate surface. The magnetic layer 2 contains Co and Pt, and may further contain oxides, Cr, B, Cu, Ta, Zr and the like in order to improve SNR characteristic.

As an oxide contained in the magnetic layer 2, SiO₂, SiO, Cr₂O₃, CoO, Ta₂O₃, TiO₂ and the like are exemplary examples.

The magnetic layer 2 may be formed of one layer and may be formed of a plurality of layers formed of materials having different compositions.

For example, in a case where the magnetic layer 2 is formed of three layers of a first magnetic layer, a second magnetic layer and a third magnetic layer, the first magnetic layer may contain Co, Cr and Pt and preferably has a granular structure formed of a material further containing an oxide. As an oxide contained in the first magnetic layer, for example, oxides of Cr, Si, Ta, Al, Ti, Mg, Co may be preferably used. Among the above, in particular, TiO₂, Cr₂O₃, SiO₂ and the like can be preferably used. Furthermore, the first magnetic layer is preferably formed of a complex oxide in which two or more kinds of oxide are added. Among the above, in particular, Cr₂O₃—SiO₂, Cr₂O₃—TiO₂, SiO₂—TiO₂ and the like can be preferably used.

The first magnetic layer can contain one or more kinds of elements selected from among B, Ta, Mo, Cu, Nd, W, Nb, Sm, Tb, Ru and Re other than Co, Cr, Pt and an oxide.

By containing the above-described elements, the refining of magnetic particles can be promoted or the crystallinity and the orientation can be enhanced, and recording and reproducing characteristics suitable for higher density recording and thermal fluctuation characteristics can be obtained.

In the second magnetic layer, the same material as the first magnetic layer can be used. The second magnetic layer preferably has a granular structure.

Furthermore, the third magnetic layer preferably has a non-granular structure formed of a material containing Co, Cr and Pt but not containing an oxide. The third magnetic layer can contain one or more kinds of elements selected from among B, Ta, Mo, Cu, Nd, W, Nb, Sm, Tb, Ru, Re and Mn other than Co, Cr and Pt. If the third magnetic layer contains the above-described elements other than Co, Cr and Pt, the refining of magnetic particles can be promoted or the crystallinity and the orientation can be enhanced, and recording and reproducing characteristics suitable for higher density recording and thermal fluctuation characteristic can be obtained.

The thickness of the magnetic layer 2 is preferably 5 nm to 25 nm. When the thickness of the magnetic layer 2 is less than 5 nm, a reproduction output is not sufficiently obtained and thermal fluctuation characteristic is also reduced. In addition, in a case where the thickness of the magnetic layer 2 is greater than 25 nm, enlargement of magnetic particles in the magnetic layer 2 is generated, noise at the time of recording and reproducing is increased, and the recording and reproducing characteristics represented by signal/noise ratio (S/N ratio) or recording characteristics (OW) is deteriorated and therefore, it is not preferable.

Moreover, in a case where the magnetic layer 2 is formed of a plurality of layers, a non-magnetic layer is preferably provided between adjacent magnetic layers. In a case where the magnetic layer 2 is formed of three layers, namely, the first magnetic layer, the second magnetic layer and the third magnetic layer, the non-magnetic layer is preferably provided between the first magnetic layer and the second magnetic layer, and between the second magnetic layer and the third magnetic layer.

By providing the non-magnetic layer having a suitable thickness between the magnetic layers, a magnetization reversal of the each film becomes easy, the dispersion of the magnetization reversal of all the magnetic particles can be reduced and the S/N ratio can be further enhanced.

As the non-magnetic layer provided between the magnetic layers, for example, Ru, Ru alloy, CoCr alloy, CoCrX1 alloy (X1 represents one or more kinds of elements selected from among Pt, Ta, Zr, Re, Ru, Cu, Nb, Ni, Mn, Ge, Si, O, N, W, Mo, Ti, V, Zr and B) can be suitably used.

Furthermore, as the non-magnetic layer provided between the magnetic layers, alloy materials containing an oxide, a metal nitride or a metal carbide are preferably used. Specifically, as an oxide, for example, SiO₂, Al₂O₃, Ta₂O₅, Cr₂O₃, MgO, Y₂O₃, TiO₂ and the like, as a metal nitride, for example, AlN, Si₃N₄, TaN, CrN and as a metal carbide, for example, TaC, BC, SiC can be used respectively.

The thickness of the non-magnetic layer provided between the magnetic layers is preferably 0.1 nm to 1 nm. By making the thickness of the non-magnetic layer be in the above-described range, the S/N ratio can be further enhanced.

The non-magnetic layer can be formed using a sputtering method.

In addition, the magnetic layer 2 is preferably a magnetic layer of the perpendicular magnetic recording in which an easy axis of magnetization is oriented in the vertical direction with respect to the substrate surface, in order to realize higher recording density, however, the magnetic layer 2 may be a magnetic layer of the in-plane magnetic recording.

The magnetic layer 2 may be formed using well-known methods in the related art such as an evaporation method, an ion beam sputtering method and a magnetron sputtering method; however, generally, the magnetic layer 2 is formed using a sputtering method.

<Protective Layer>

The protective layer 3 protects a recording layer 2. The protective layer 3 may be formed of one layer and may be formed of a plurality of layers. The protective layer 3 in an embodiment of the present invention is formed of carbon or silicon carbide and is preferably formed of carbon.

A lubricant agent layer 4 formed on the protective layer 3 has a high bonding force with respect to carbon.

In a case where the protective layer 3 is formed of carbon or silicon carbide, carbon atoms contained in the protective layer 3 and the lubricant agent layer 4 are bonded and therefore, the protective layer 3 and the lubricant agent layer 4 are bonded using a high bonding force. As a result, a magnetic recording medium 11 in which the surface of the protective layer 3 is coated with high coverage is obtained even if the thickness of the lubricant agent layer 4 is thin and the contamination of the surface of the magnetic recording medium 11 can be effectively prevented.

In particular, in a case where the protective layer 3 is formed of carbon, the bonding force between the lubricant agent layer 4 and the protective layer 3 due to bonding of carbon atoms contained in the protective layer 3 and the lubricant agent layer 4 is further increased. Accordingly, in a case where the protective layer 3 is formed of carbon, the contamination of the surface of the magnetic recording medium 11 can be further effectively prevented and the surface of the protective layer 3 can be coated with sufficiently high coverage even if the thickness of the lubricant agent layer 4 is decreased.

The film thickness of the protective layer 3 is preferably in the range of 1 nm to 10 nm and more preferably in the range of 3 nm to 7 nm. In a case where the film thickness of the protective layer 3 is in the range of 1 nm to 10 nm, it is possible to sufficiently reduce the magnetic spacing in the magnetic recording and reproducing device provided with the magnetic recording medium 11 of an embodiment of the present invention, correspond to the further improvement in a recording density and enhance durability. Moreover, the magnetic spacing means the distance between the magnetic head and the magnetic layer 4. The electromagnetic conversion characteristic of the magnetic recording and reproducing device can be enhanced as the magnetic spacing is narrowed.

When the film thickness of the protective layer 3 is less than 1 nm, there are cases where the effect protecting the recording layer 2 is insufficient. Furthermore, when the film thickness of the protective layer 3 is greater than 10 nm, there are cases where the decrease of the magnetic spacing is insufficient.

As a film forming method of the protective layer 3, a sputtering method using a carbon target material, CVD (chemical vapor deposition) method using a hydrocarbon material such as ethylene or toluene and IBD (ion beam deposition) method can be used.

<Lubricant Agent Layer>

The lubricant agent layer 4 prevents the contamination of the magnetic recording medium 11, reduces the frictional force of the magnetic head of the magnetic recording and reproducing device which slides on the magnetic recording medium and therefore, the durability of the magnetic recording medium 11 is enhanced.

As shown in FIG. 1, the lubricant agent layer 4 is formed by being in contact with the protective layer 3, contains compound A shown in the above general formula (1) and compound B which is any one selected from compound B1 shown in the above general formula (2), compound B2 shown in the above general formula (3), compound B3 shown in the above general formula (4) and compound B4 shown in the above general formula (5).

In the above general formula (1), x is an integer of 1 to 5, R₁ is any one of a hydrogen atom, an alkyl group having 1 to 4 carbon atoms or a halogenated alkyl group having 1 to 4 carbon atoms, R₂ is a substituent of which a terminal group is —CH₂OH or —CH(OH)CH₂OH. In the above general formula (2), m is an integer in the range of 4 to 60. In the above general formula (3), n is an integer in the range of 4 to 36. In the following general formula (4), r is an integer in the range of 4 to 60. In the following general formula (5), a, b, c and d are integers in the range of 4 to 40.

<Compound A>

Compound A shown in the above general formula (1) is a phosphazene compound. As compound A shown in the general formula (1), specifically, X-1p (trade name, manufactured by Dow Chemical Co., Ltd.), MORESCO PHOSPHAROL A20H-2000 (trade name, manufactured by Matsumura Oil Research (MORESCO)), A20H-DD (trade name, manufactured by Matsumura Oil Research (MORESCO)), ADOH-2000 (trade name, manufactured by Matsumura Oil Research (MORESCO)) or reaction products which are synthesized from related materials thereof as starting materials and are purified are exemplary examples.

As compound A, compounds in which x is 5, R₁ is CF₃ and R₂ is —OCH₂CF₂O(CF₂CF₂O)ₜ(CF₂O)ᵤCF₂CH₂OH (t is 10.5, u is 10.1) in the above general formula (1) are preferably used.

As the compound A, A20H-2000 (trade name, manufactured by Matsumura Oil Research (MORESCO)) is an exemplary example.

Furthermore, as compound A, compounds in which x is 5, R₁ is CF₃ and R₂ is —OCH₂CF₂O(CF₂CF₂O)ₚ(CF₂O)_{q}CF₂CH₂OCH₂CH(OH)CH₂OH (p is 10.7, q is 10.4) in the above general formula (1) are preferably used.

As the compound A, ADOH-2000 (trade name, manufactured by Matsumura Oil Research (MORESCO)) is an exemplary example.

Furthermore, as compound A, compounds in which x is 4, R₁ is CF₃ and R₂ is a substituent group having a terminal group of —CH(OH)CH₂OH in the above general formula (1) are preferably used.

As the compound A, A20H-DD (trade name, manufactured by Matsumura Oil Research (MORESCO)) is an exemplary example.

<Compound B1>

Compound B1 shown in the above general formula (2) preferably has the average molecular weight in the range of 1000 to 8000. This is because the compound B1 has a low boiling point and thermal stability of the lubricant agent is impaired when the average molecular weight of the compound B1 is less than 1000. On the other hand, this is because the compound B1 has high viscosity and coating properties of the compound B1 is degraded when the average molecular weight of the compound B1 is greater than 8000.

As compound B1, for example, D4OH (trade name) manufactured by MORSCO Corporation is an exemplary example.

D4OH has m in the general formula (2) in the range of 4 to 30 and has the average molecular weight in the range of 1000 to 5000.

<Compound B2>

Compound B2 shown in the above general formula (3) preferably has the average molecular weight in the range of 1000 to 5000.

As compound B2, for example, QA-40 (trade name) manufactured by Asahi Glass Co., Ltd. is an exemplary example. QA-40 has n in the general formula (3) in the range of 4 to 10 and has the average molecular weight in the range of 2000 to 5000.

<Compound B3>

Compound B3 shown in the above general formula (4) preferably has an average molecular weight in the range of 1000 to 8000.

As compound B3, r in the above general formula (4) is preferably in the range of 4 to 30 and the average molecular weight is in the range of 1000 to 5000.

<Compound B4>

Compound B4 shown in the above general formula (5) preferably has the average molecular weight in the range of 1000 to 5000.

As compound B4, for example, QG-40 (trade name) manufactured by Asahi Glass Co., Ltd. in which a terminal group of QA-40 (trade name) manufactured by Asahi Glass Co., Ltd. is substituted with tetraol. QG-40 has a, b, c and d in the general formula (5) in the range of 4 to 10 and has the average molecular weight in the range of 2000 to 5000.

<Mass Ratio (A/B)>

In the lubricant agent layer 4, the mass ratio (A/B) of compound A with respect to compound B is in the range of 0.05 to 0.9 and preferably in the range of 0.1 to 0.5. The mass ratio (A/B) can be in the range of 0.05 to 0.9. Accordingly, the bond between a phosphazene skeleton of the compound A and carbon atoms constituting the protective layer 3 become strong, and the protective layer 3 formed of compound B and the lubricant agent layer 4 are bonded using a sufficiently high bonding force. Furthermore, in a case where the mass ratio (A/B) is in the range of 0.1 to 0.5, the bonding force between the protective layer 3 and the lubricant agent layer 4 is further increased and therefore, penetration of environmental materials that generate contaminants from voids of the lubricant agent layer 4 can be effectively prevented.

In a case where the mass ratio (A/B) is less than 0.05, compound A is insufficient and therefore, the lubricant agent layer 4 are likely in an island shape and the coverage of the protective layer 3 becomes insufficient. Furthermore, in a case where the mass ratio (A/B) is greater than 0.9, compound B is insufficient and therefore, the lubricant agent layer 4 are likely in a mesh-like shape and the coverage of the protective layer 3 becomes insufficient.

<Film Thickness of Lubricant Agent Layer>

The average film thickness of the lubricant agent layer 4 is in the range of 0.8 nm (8 angstrom) to 2 nm (20 angstrom) and preferably in the range of 1 nm to 1.9 nm.

By making the average film thickness of the lubricant agent layer 4 be 0.8 nm or greater, the surface of the protective layer 3 can be uniformly coated with high coverage so as not to be in an island shape or a mesh-like shape.

Furthermore, by making the film thickness of the lubricant agent layer 4 be 2 nm or less, the flying height of the magnetic head becomes sufficiently small and therefore, the recording density of the magnetic recording medium 11 can be increased.

Moreover, since compound A has a large molecular structure called a phosphazene skeleton, a film of which the average film thickness formed using only compound A is 2 nm or less becomes an island shape or a mesh-like shape and the surface of the protective layer 3 cannot be coated with sufficiently high coverage.

Furthermore, a film of which the average film thickness formed using only compound B is 2 nm or less also becomes an island shape or a mesh-like shape and the surface of the protective layer 3 cannot be coated with sufficiently high coverage.

In a case where the surface of the protective layer 3 is not coated with sufficiently high coverage using the lubricant agent layer 4, water containing environmental materials that generate contaminants such as ionic impurities adsorbed on the surface of the magnetic recording medium 11 penetrates into a lower part of the lubricant agent layer 4 through voids of the lubricant agent layer 4. The environmental materials penetrated into a lower layer of the lubricant agent layer aggregate small ionic components hidden in the lower part of the lubricant agent layer 4, thereby generating ionic contaminants. Then, when a magnetic recording and reproducing is performed, the contaminants (aggregating components) are adhered (transferred) onto the magnetic head, and as a result, the magnetic head is damaged or the magnetic recording and reproducing characteristics of the magnetic recording and reproducing device is reduced.

Such a problem due to the penetration of environmental materials from voids of the lubricant agent layer 4 is remarkably exhibited in a case where the magnetic recording medium 11 is kept under a high temperature condition.

Environmental materials that generate contaminants, for example, are ionic impurities. As metal ions contained in the ionic impurities, for example, sodium ions and potassium ions can be exemplified and as inorganic ions, for example, silicon ions, chloride ions, HCO₃ ions, HSO₄ ions, sulfate ions, ammonium ions, oxalate ions and formate ions are exemplary examples.

<Lubricant Agent Layer-Forming Method>

In order to form the lubricant agent layer 4, for example, a magnetic recording medium during production in which each layer up to the protective layer 3 was formed on the non-magnetic substrate 1 is prepared and a lubricant agent layer-forming solution is coated on the protective layer 3 of the magnetic recording medium during production.

The lubricant agent layer-forming solution is prepared as described below. compound A and compound B are mixed such that the mass ratio (A/B) of compound A with respect to compound B becomes in the range of 0.05 to 0.9, the resultant is diluted with a solvent to have viscosity and concentration suitable for a coating method.

As a solution used in the lubricant agent layer-forming solution, for example, fluorine-based solvents such as Vertrel XF (trade name, manufactured by DuPont-Mitsui Fluorochemicals Co., Ltd.).

The coating method of the lubricant agent layer-forming solution is not particularly limited, and, for example, a spin coating method, a dip method are exemplary examples thereof.

In a case where a dip method is used, for example, a method can be used that the non-magnetic substrate 1 in which each layer up to the protective layer 3 was formed is dipped in the lubricant agent layer-forming solution placed in a dipping bath of a dip coating device, thereafter, by pulling the non-magnetic substrate 1 at a predetermined speed from the dipping bath, the lubricant agent layer-forming solution is coated on the surface of the protective layer 3 of the non-magnetic substrate 1. By using a dip method, the lubricant agent layer-forming solution can be coated uniformly on the surface of the protective layer 3 of the non-magnetic substrate 1 and the lubricant agent layer 4 having a uniform film thickness can be formed on the protective layer 3.

The magnetic recording medium 11 according to an embodiment of the present invention is the magnetic recording medium 11 that has at minimum the magnetic layer 2, the protective layer 3 and the lubricant agent layer 4 on the non-magnetic substrate 1 in sequential order, in which the protective layer 3 is formed of carbon or silicon carbide and the lubricant agent layer 4 is formed by being in contact with the protective layer 3, which contains compound A shown in the above general formula (1) and compound B which is any one selected from compound B1 shown in the above general formula (2), compound B2 shown in the above general formula (3), compound B3 shown in the above general formula (4) and compound B4 shown in the above general formula (5), in which the mass ratio (A/B) of the compound A with respect to compound B is in the range of 0.05 to 0.9, and the average film thickness of the lubricant agent layer 4 is 0.8 nm (8 angstroms) to 2 nm (20 angstroms). Thus, a phosphazene skeleton formed of a phosphazene compound of compound A and compound B are strongly bonded to carbon atoms contained in the protective layer 3, the lubricant agent layer 4 and the protective layer 3 are bonded using a high bonding force, and the thickness of the lubricant agent layer 4 is sufficiently decreased.

That is, the magnetic recording medium 11 according to an embodiment of the present invention is provided with a lubricant agent layer which can substantially uniformly coat the surface of a protective layer with high coverage so as not to become an island shape or a mesh-like shape even if the thickness is reduced. Thus, in the magnetic recording medium 11 according to an embodiment of the present invention, the penetration of environmental materials that generate contaminants such as ionic impurities from voids of the lubricant agent layer 4 is prevented. Accordingly, the magnetic recording medium 11 of an embodiment of the present invention has a small amount of contaminants present on the magnetic recording medium.

Furthermore, as compound A, compounds in which x is 5, R₁ is CF₃ and R₂ is —OCH₂CF₂O(CF₂CF₂O)ₜ(CF₂O)ᵤCF₂CH₂OH (t is 10.5, u is 10.1) in the above general formula (1) or x is 5, R₁ is CF₃ and R₂ is —OCH₂CF₂O(CF₂CF₂O)ₚ(CF₂O)_{q}CF₂CH₂OCH₂CH(OH)CH₂OH (p is 10.7, q is 10.4) in the above general formula (1) can be used. In this case, a phosphazene skeleton formed of a phosphazene compound of compound A and compound B are more strongly bonded to carbon atoms contained in the protective layer 3, and the lubricant agent layer 4 and the protective layer 3 are bonded by a further high bonding force.

As compound A, compounds in which x is 4, R₁ is CF₃ and R₂ is a substituent group having a terminal group of —CH(OH)CH₂OH in the above general formula (1) can be used. In this case, since the substituent groups having a terminal group formed of —CH(OH)CH₂OH in the above general formula (1) is also bonded to the bond with the carbon atoms contained in the protective layer 3 which a phosphazene skeleton of compound A and compound B form, the lubricant agent layer 4 and the protective layer 3 become the magnetic recording medium 11 bonded using a higher bonding force and the surface of the protective layer 3 can be protected more strongly.

Furthermore, in an embodiment of the present invention, compound B is compound B1 shown in the above general formula (2) or compound B3 shown in the above general formula (4) and the average molecular weight of the compound B can be in the range of 1000 to 8000. Furthermore, in an embodiment of the present invention, compound B is compound B2 shown in the above general formula (3) or compound B4 shown in the above general formula (5) and the average molecular weight of the compound B can be in the range of 1000 to 5000. In any case, compound B is likely embedded into voids in a phosphazene skeleton formed of a phosphazene compound of compound A, the lubricant agent layer 4 becomes a layer in which voids is less likely formed, environmental materials that generate contaminants are unlikely to penetrate into a lower layer of the lubricant agent layer 4 and the magnetic recording medium 11 is unlikely to be contaminated.

<Magnetic Recording and Reproducing Device>

Next, an example of the magnetic recording and reproducing device according to embodiment of the present invention will be described. FIG. 2 is a perspective view showing an example of the magnetic recording medium according to embodiment of the present invention.

A magnetic recording and reproducing device 101 according to an embodiment of the present invention is provided with the magnetic recording medium 11 according to an embodiment of the present invention shown in FIG. 1, a medium driving portion 123 for driving the magnetic recording medium 11 to the recording direction, a magnetic head 124 formed of a recording portion and a reproducing portion, a head moving portion 126 that relatively moves the magnetic head 124 with respect to the magnetic recording medium 11, a recording and reproducing signal processing portion 128 used to process recording and reproducing signals from the magnetic head 124.

By making an element portion (reproducing portion) of the magnetic head 124 with a GMR head or a TMR head, it is possible to obtain a sufficient signal strength even at high recording density and realize a magnetic recording and reproducing device having high recording density.

Furthermore, in a case where the flying height of the magnetic head 124 is floated at a height of 0.005 μm (5 nm) to 0.020 μm (20 nm) which is lower than the flying height in the related art, output is improved and thus, a high SNR can be obtained, and can be a magnetic recording and reproducing device of high-capacity having high reliability.

The magnetic recording and reproducing device 101 of an embodiment of the present invention is provided with the magnetic recording medium 11 on which a small amount of contaminants is present. Accordingly, the reduction of recording and reproducing characteristics or the impairing of the flying stability caused by transferring contaminants present on the magnetic recording medium 11 to the magnetic head 124 of the magnetic recording and reproducing device 101 are prevented. Therefore, the magnetic recording and reproducing device 101 of the present invention has a stable magnetic recording and reproducing characteristics.

### EXAMPLES

Hereinafter, the present invention will be described in detail with reference to Examples. However, the present invention is not limited to these Examples.

### Examples 1 to 30 and Comparative Examples 1 to 10

A cleaned glass substrate (manufactured by HOYA Corp., an external size of 2.5 inches) was accommodated in a film formation chamber of a DC magnetron sputter device (trade name C-3040 manufactured by ANELVA CORPORATION), and then, the inside of the film formation chamber was exhausted until the degree of vacuum reached 1×10⁻⁵ Pa.

Then, an adhesion layer having a thickness of 10 nm was formed on the glass substrate using a Cr target using a sputtering method.

Then, a first soft magnetic layer having a thickness of 25 nm was formed at a substrate temperature of 100° C. or lower using a target of Co-20Fe-5Zr-5Ta {Fe of 20 at %, Zr of 5 at %, Ta of 5 at % and residual Co} on the adhesion layer as a soft magnetic underlayer using a sputtering method and an intermediate layer formed of Ru film having a thickness of 0.7 nm and a second soft magnetic layer having a thickness of 25 nm formed of Co-20Fe-5Zr-5Ta were formed thereon.

Then, a seed layer having a thickness of 5 nm was formed on the soft magnetic underlayer using a Ni-6W {W of 6 at % and residual Ni} target using a sputtering method.

Thereafter, a Ru layer having a thickness of 10 nm was formed on the seed layer as a first orientation control layer at a sputtering pressure of 0.8 Pa using a sputtering method. Then, a Ru layer having a thickness of 10 nm was formed on the first orientation control layer as a second orientation control layer at a sputtering pressure of 1.5 Pa using a sputtering method.

Subsequently, a first magnetic layer formed of 91(Co15Cr16Pt)-6(SiO₂)-3(TiO₂) {Cr of 15 at %, Pt of 16 at %, residual Co alloy of 91 mol %, oxide of 6 mol % formed of SiO₂ and oxide of 3 mol % formed of TiO₂} having a thickness of 9 nm was formed on the second orientation control layer at a sputtering pressure of 2 Pa using a sputtering method.

Then, a non-magnetic layer formed of 88(Co30Cr)-12(TiO₂) {Cr of 30 at %, residual Co alloy of 88 mol %, oxide of 12 mol % formed of TiO₂} having a thickness of 0.3 nm was formed on the first non-magnetic layer using a sputtering method.

Thereafter, the second magnetic layer formed of 92(Co11Cr18Pt)-5(SiO₂)-3(TiO₂) {Cr of 11 at %, Pt of 18 at %, residual Co alloy of 92 mol %, oxide of 5 mol % formed of SiO₂, oxide of 3 mol % formed of TiO₂} having a thickness of 6 nm was formed on the non-magnetic layer at a sputtering pressure of 2 Pa using a sputtering method.

Thereafter, a non-magnetic layer formed of Ru having a thickness of 0.3 nm was formed on the second magnetic layer using a sputtering method.

Then, a third magnetic layer having a thickness of 7 nm was formed on the non-magnetic layer at a sputtering pressure of 0.6 Pa using a target formed of Co-20Cr-14Pt-3B {Cr of 20 at %, Pt of 14 at %, B of 3 at % and residual Co} using a sputtering method.

Then, a protective layer having a thickness of 3.0 nm formed of C was formed using a CVD method.

Then, a lubricant agent layer was formed on the protective layer in the following manner using a dip method.

As compound A, A20H-2000 (trade name, manufactured by Matsumura Oil Research (MORESCO)) (abbreviated as “A20H” in Table 1) or ADOH-2000 (trade name, manufactured by MORESCO Corporation) (abbreviated as “ADOH” in Table 1) were used as shown in FIG. 1.

In addition, as compound B, any one of D4OH (product name) manufactured by MORSCO Corporation, QA-40 (product name) manufacture by Asahi Glass Co., Ltd. and QG-40 (product name) manufacture by Asahi Glass Co., Ltd. was used.

Then, compound A and compound B were mixed and the lubricant agent layer-forming solutions of Examples 1 to 30 were adjusted such that the mass ratio (A/B) of compound A with respect to compound B becomes 0.05 to 0.9.

The lubricant agent layer-forming solutions of Comparative Example 1 and Comparative Example 2 formed of only compound A and the lubricant agent layer-forming solutions of Comparative Examples 3 to 5 formed of only compound B were adjusted.

Then, compound A and compound B were mixed and the lubricant agent layer-forming solutions of Comparative Examples 6 to 10 were adjusted such that the mass ratio (A/B) of compound A with respect to compound B becomes 0.04, 0.03, 1.0, 1.5 and 0.4.

Moreover, Vertrel XF was used (trade name, manufactured by Du Pont-Mitsui Fluorochemicals Co., Ltd.) as a solvent for dissolving the lubricant agent layer-forming solutions of Examples 1 to 30 and Comparative Examples 1 to 10. Further, the concentration of the lubricant agent in all the lubricant agent layer-forming solutions of Examples 1 to 30 and Comparative Examples 1 to 10 was set to be 0.3% by mass.

Then, the lubricant agent layer-forming solutions of Examples 1 to 30 and Comparative Examples 1 to 10 were coated on the protective layer of the non-magnetic substrate, respectively, using a dip method as described below.

That is, the non-magnetic substrate on which each layer up to the protective layer was formed was dipped in the lubricant agent layer-forming solution placed in a dipping bath of a dip coating device, thereafter, by pulling the non-magnetic substrate at a constant speed from the dipping bath, the lubricant agent layer-forming solution was coated on the surface of the protective layer of the non-magnetic substrate.

Thereafter, by drying the surface coated with the lubricant agent layer-forming solution to form a lubricant agent layer, magnetic recording media of Examples 1 to 30 and Comparative Examples 1 to 10 were obtained.

The mass ratio (A/B) of compound A with respect to compound B of the magnetic recording medium and the average film thickness of the lubricant agent layer obtained in this way were shown in Table 1.

(Evaluation of Resistance to Environment of Magnetic Recording Medium)

A resistance to environment of the magnetic recording media of Examples 1 to 30 and Comparative Examples 1 to 10 was evaluated using the following method. Evaluation of the resistance to environment described below is one of the evaluation method which examines the contamination of the magnetic recording medium with environmental materials that generate contaminants under a high-temperature environment. In the evaluation of the resistance to environment described below, the amount of adsorbed Si was measured as the amount of contaminants contaminating the magnetic recording medium generated with environmental materials, using Si ion as environmental materials that generate contaminants in a high-temperature environment.

Specifically, first, a magnetic recording medium to be evaluated was held for 240 hours in the presence of siloxane-based Si rubber under a high-temperature environment of a temperature of 85° C. and humidity of 0%.

Then, the amount of adsorbed Si present on the surface of a magnetic recording medium was analyzed and measured using tof-SIMS (time of flight-Secondary Ion Mass Spectrometry) and the degree of contamination with Si ions which is an environmental material under a high-temperature environment was evaluated as the amount of adsorbed Si.

Moreover, the evaluation of the amount of adsorbed Si was performed using the value when the degree of contamination with Si ions of the reference disk on which a lubricant agent layer was formed by coating 1.7 nm of tetraol (manufactured by Solvay Solexis Inc.) on a non-magnetic substrate in which each layer up to the protective layer was set as 1. The results are shown in Table 1.

TABLE 1

| | | | AVERAGE FILM | MASS | AMOUNT OF |
|---|---|---|---|---|---|
| | COMPOUND | COMPOUND | THICKNESS | RATIO | ADSORBED Si |
| | A | B | (nm) | (A/B) | (ARBITRARY VALUE) |
| EXAMPLE 1 | A2OH | D4OH | 1.4 | 0.05 | 10 |
| EXAMPLE 2 | A2OH | D4OH | 1.4 | 0.2 | 5 |
| EXAMPLE 3 | A2OH | D4OH | 1.4 | 0.4 | 5 |
| EXAMPLE 4 | A2OH | D4OH | 1.4 | 0.6 | 10 |
| EXAMPLE 5 | A2OH | D4OH | 1.4 | 0.9 | 10 |
| EXAMPLE 6 | A2OH | QA-40 | 1.7 | 0.05 | 15 |
| EXAMPLE 7 | A2OH | QA-40 | 1.7 | 0.2 | 10 |
| EXAMPLE 8 | A2OH | QA-40 | 1.7 | 0.4 | 5 |
| EXAMPLE 9 | A2OH | QA-40 | 1.7 | 0.6 | 5 |
| EXAMPLE 10 | A2OH | QA-40 | 1.7 | 0.9 | 10 |
| EXAMPLE 11 | A2OH | QG-40 | 1.7 | 0.05 | 15 |
| EXAMPLE 12 | A2OH | QG-40 | 1.7 | 0.2 | 10 |
| EXAMPLE 13 | A2OH | QG-40 | 1.7 | 0.4 | 5 |
| EXAMPLE 14 | A2OH | QG-40 | 1.7 | 0.6 | 10 |
| EXAMPLE 15 | A2OH | QG-40 | 1.7 | 0.9 | 15 |
| EXAMPLE 16 | ADOH | D4OH | 1.4 | 0.05 | 10 |
| EXAMPLE 17 | ADOH | D4OH | 1.4 | 0.2 | 10 |
| EXAMPLE 18 | ADOH | D4OH | 1.4 | 0.4 | 5 |
| EXAMPLE 19 | ADOH | D4OH | 1.4 | 0.6 | 10 |
| EXAMPLE 20 | ADOH | D4OH | 1.4 | 0.9 | 15 |
| EXAMPLE 21 | ADOH | QA-40 | 1.7 | 0.05 | 10 |
| EXAMPLE 22 | ADOH | QA-40 | 1.7 | 0.2 | 5 |
| EXAMPLE 23 | ADOH | QA-40 | 1.7 | 0.4 | 5 |
| EXAMPLE 24 | ADOH | QA-40 | 1.7 | 0.6 | 5 |
| EXAMPLE 25 | ADOH | QA-40 | 1.7 | 0.9 | 10 |
| EXAMPLE 26 | ADOH | QG-40 | 1.7 | 0.05 | 15 |
| EXAMPLE 27 | ADOH | QG-40 | 1.7 | 0.2 | 10 |
| EXAMPLE 28 | ADOH | QG-40 | 1.7 | 0.4 | 5 |
| EXAMPLE 29 | ADOH | QG-40 | 1.7 | 0.6 | 10 |
| EXAMPLE 30 | ADOH | QG-40 | 1.7 | 0.9 | 15 |
| COMPARATIVE EXAMPLE 1 | A2OH | — | 1.4 | — | 60 |
| COMPARATIVE EXAMPLE 2 | ADOH | — | 1.4 | — | 60 |
| COMPARATIVE EXAMPLE 3 | — | D4OH | 1.4 | 0 | 150 |
| COMPARATIVE EXAMPLE 4 | — | QA-40 | 1.7 | 0 | 300 |
| COMPARATIVE EXAMPLE 5 | — | QG-40 | 1.7 | 0 | 300 |
| COMPARATIVE EXAMPLE 6 | ADOH | D4OH | 1.4 | 0.04 | 20 |
| COMPARATIVE EXAMPLE 7 | ADOH | D4OH | 1.4 | 0.03 | 35 |
| COMPARATIVE EXAMPLE 8 | ADOH | D4OH | 1.4 | 1 | 20 |
| COMPARATIVE EXAMPLE 9 | ADOH | D4OH | 1.4 | 1.5 | 30 |
| COMPARATIVE EXAMPLE 10 | ADOH | D4OH | 0.7 | 0.4 | 300 |

It was made clear from Table 1 that in the magnetic recording media of Examples 1 to 30, the amount of adsorbed Si is very small and the magnetic recording media is unlikely contaminated with environmental materials under a high-temperature environment, compared to the magnetic recording media of Comparative Example 1 and Comparative Example 2 formed of only compound A, Comparative Examples 3 to 5 formed of only compound B, Comparative Examples 6 to 9 in which the mass ratio (A/B) of compound A with respect to compound B is in the range outside the present invention, Comparative Example 10 in which the average film thickness of a lubricant agent layer is in the range outside the present invention.

The magnetic recording medium and the magnetic recording and reproducing device of the present invention are applicable in the industry which uses and produces a magnetic recording medium and a magnetic recording and reproducing device having a high recording density.

While preferred embodiments of the invention have been described and illustrated above, it should be understood that these are examples of the invention and are not considered as limiting. Additions, omissions, substitutions, and other modifications can be made without departing from the spirit or scope of the present invention. Accordingly, the invention is not considered as being limited by the foregoing description, and is only limited by the scope of the appended claims.

What is claimed is:

1. A magnetic recording medium comprising at minimum a magnetic layer, a protective layer and a lubricant agent layer on a non-magnetic substrate in sequential order,
wherein the protective layer is formed of carbon or silicon carbide,
the lubricant agent layer is formed by being in contact with the protective layer, and contains compound A represented in the below general formula (1) and compound B,
in which the compound B is any one selected from compound B1 represented in the below general formula (2), compound B2 represented in the below general formula (3), compound B3 represented in the below general formula (4) and compound B4 represented in the below general formula (5),
wherein the mass ratio (A/B) of the compound A with respect to the compound B is in the range of 0.05 to 0.9, and
wherein the average film thickness of the lubricant agent layer is 0.8 nm to 2 nm. 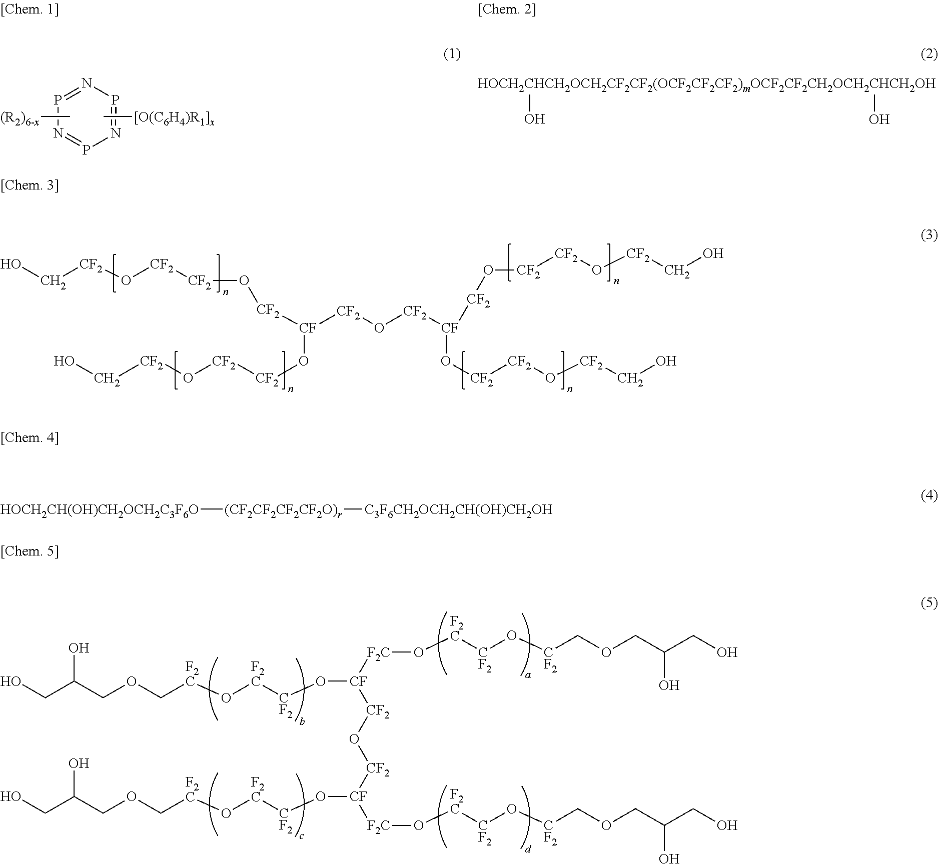
[In the general formula (1), x is an integer of 1 to 5, R₁ is any one of a hydrogen atom, an alkyl group having 1 to 4 carbon atoms or a halogenated alkyl group having 1 to 4 carbon atoms and R₂ is a substituent of which a terminal group is —CH₂OH or —CH(OH)CH₂OH. In the above general formula (2), m is an integer in the range of 4 to 60. In the above general formula (3), n is an integer in the range of 4 to 36. In the following general formula (4), r is an integer in the range of 4 to 60. In the following general formula (5), a, b, c and d are integers in the range of 4 to 40.]

2. The magnetic recording medium according to claim 1,
wherein in the above general formula (1), x is 5, R₁ is CF₃ and R₂ is —OCH₂CF₂O(CF₂CF₂O)ₜ(CF₂O)ᵤCF₂CH₂OH (t is 10.5 and u is 10.1).

3. The magnetic recording medium according to claim 1,
wherein in the above general formula (1), x is 5, R₁ is CF₃ and R₂ is —OCH₂CF₂O(CF₂CF₂O)ₚ(CF₂O)_{q}CF₂CH₂OCH₂CH(OH)CH₂OH (p is 10.7 and q is 10.4).

4. The magnetic recording medium according to claim 1,
wherein in the above general formula (1), x is 4, R₁ is CF₃ and R₂ is a substituent having a terminal group of —CH(OH)CH₂OH.

5. The magnetic recording medium according to claim 1,
wherein the compound B is compound B1 represented in the above general formula (2) or compound B3 represented in the above general formula (4) and the average molecular weight of the compound B is in the range of 1000 to 8000.

6. The magnetic recording medium according to claim 1,
wherein the compound B is compound B2 represented in the above general formula (3) or compound B4 represented in the above general formula (5) and the average molecular weight of the compound B is in the range of 1000 to 5000.

7. A magnetic recording and reproducing device comprising:
the magnetic recording medium according to claim 1,
a medium driving portion that drives the magnetic recording medium to a recording direction;
a magnetic head that records and reproduces information onto the magnetic recording medium;
a head moving portion that relatively moves the magnetic head with respect to the magnetic recording medium; and
a recording and reproducing signal processing portion that processes recording and reproducing signals from the magnetic head.
